(19) United States
(12) Patent Application Publication
(10) Pub. No.: US 2013/0107049 A1
(43) Pub. Date: May 2, 2013

(54) ACCIDENT AVOIDING SYSTEM AND METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/473,662

(22) Filed: May 17, 2012

(30) Foreign Application Priority Data
Oct. 31, 2011 (TW) 100139658

(51) Int. Cl. B60Q 1/00; H04N 7/18

(52) U.S. Cl. 348/148; 348/E07.085

(57) ABSTRACT

The accident avoiding system includes an image obtaining unit, a detection module, a location analysis module, and a determination module. The image obtaining unit captures the image of the scene behind the car. The detection module analyzes whether there is a moving object in the captured images. The location analysis module analyzes the relative distance and the relative position between the moving object and the car. The determination module determines the warning level according to the analyzed results for preventing accidents. The disclosure further provides an accident avoiding method.

### BACKGROUND

1. Technical Field

The present disclosure relates to an accident avoiding system and an accident avoiding method, and particularly to a traffic accident avoiding system and a traffic accident avoiding method for preventing accidents when opening a car door.

2. Description of Related Art

When the driver or the passenger tries to open a car door, they should keep a proper lookout for oncoming traffic. The driver or the passenger must check whether there is any oncoming traffic and whether the distance between the oncoming traffic and the driver or the passenger is long enough and then open the car door. However, there are blind spots the driver or passenger may not be aware of, therefore accidents still may result from opening a car door

What is needed, therefore, is an accident avoiding system capable of overcoming the limitation described.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of a preferred embodiment of an accident avoiding system of the present disclosure.

FIG. 2 and FIG. 3 are the operating diagrams of the accident avoiding system in FIG. 1.

FIG. 4 is a flowchart of a first preferred embodiment of an accident avoiding method of the present disclosure.

FIG. 5 is a continuation of the flowchart of the first preferred embodiment of an accident avoiding method of the present disclosure.

### DETAILED DESCRIPTION

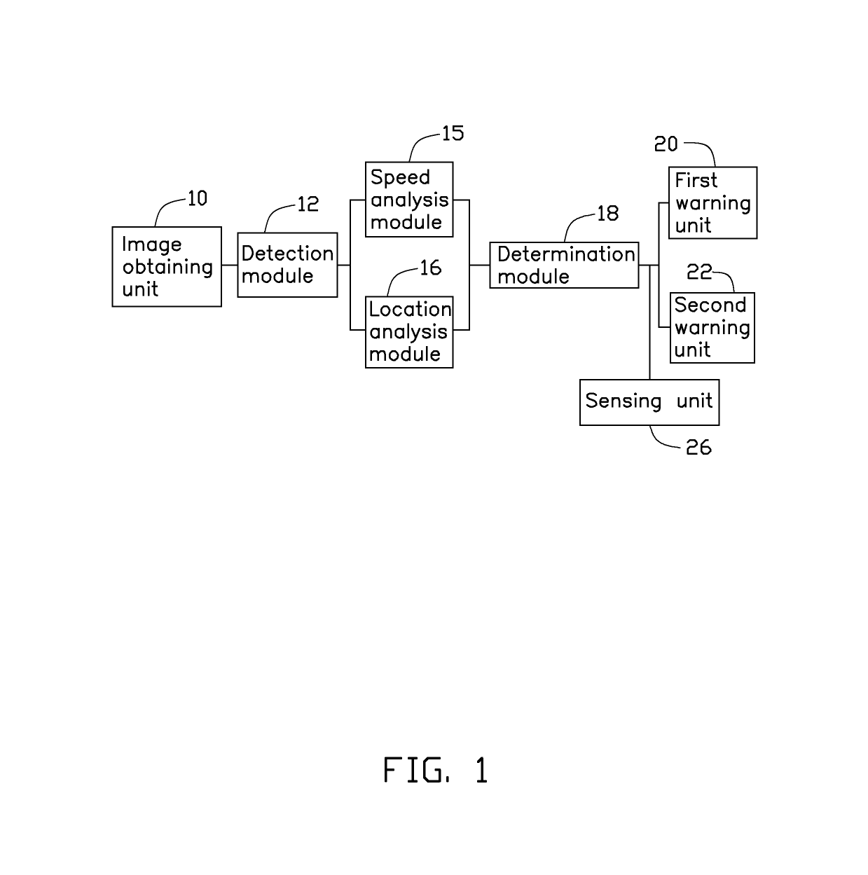

As shown in FIG. 1, a preferred embodiment of the accident avoiding system includes an image obtaining unit 10, a detection module 12, a speed analysis module 15, a location analysis module 16, a determination module 18, a first warning unit 20, a second warning unit 22 and a sensing unit 26.

The image obtaining unit 10 is installed on the body of the car and utilized for capturing the images of the scene behind the car and obtaining the distance information including distances between points on an object and the image obtaining unit 10. In an embodiment, the distance information is included in the captured images. In an embodiment, the image obtaining unit 10 can be a depth-sensing camera, such as a time-of-fight (TOF) camera. The TOF camera can emit a signal with a particular wavelength when capturing the image. When the signal reaches the object, the signal would be reflected and then received by the TOF camera. The difference between the emitting time and the receiving time is directly proportional to the distance between the object and the TOF camera. Thereby, the TOF camera can obtain the distance information indicating distances between points on an object and the image obtaining unit 10. In addition, in order to capture the image of the whole scene behind the car, another embodiment of the accident avoiding system in the present invention further includes a plurality of the image obtaining units 10 respectively installed on the car doors. In a preferred embodiment, the image obtaining unit 10 can be selected from the cameras with the function of depth determination.

The detection module 12 is utilized to analyze the captured images and the distance information for determining whether there is a moving object.

The method for determining whether there is a moving object or not is as follows. In the embodiment, the image obtaining unit 10 captures the images every particular time interval, such as one second, and obtains the distance information including distances between the image obtaining unit 10 and points on an object behind the car. The distance information can be transferred as pixel values by the detection module 12, wherein the maximum distance information corresponds to the pixel value “255” and the minimum distance information corresponds to the pixel value “0”.

After obtaining the image arrays having the pixel values of the distance information, two successive image arrays are compared with each other to find the similar area by the detection module 12 and then the location of the similar area in the two image arrays would be calibrated. After calibrating, there is a moving object in the scene if there are some different pixel values between the distance information of the two successive image arrays. In other embodiment, the captured image and the distance information can be analyzed by other algorithms for determining the moving object.

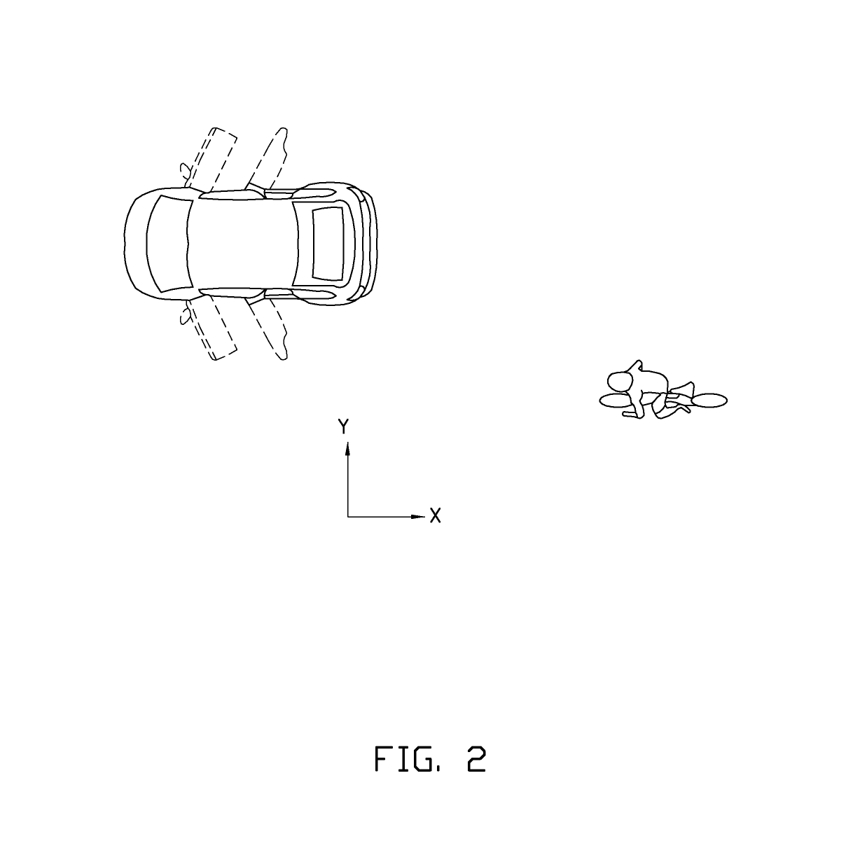

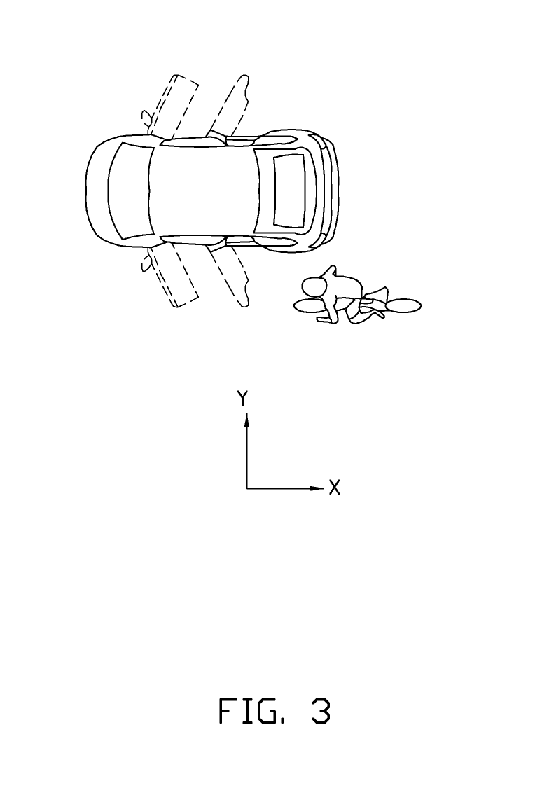

Then, the location analysis module 16 analyzes the captured image and the distance information to obtain the relative distance and the relative position between the moving object and the image obtaining unit 10. For example, the distance in FIG. 2 between the car and the moving object is 10 meter along the x-axis and 1 meter along the y-axis. The distance in FIG. 3 is 0.5 meter along the y-axis. In addition, the moving object in FIG. 3 is close to the car in the direction of the x-axis. If the image obtaining units 10 are installed on every car door, the location analysis module 16 will obtain relative positions between the moving object and the corresponding doors.

The speed analysis module 15 analyzes at least two of the captured images, such as two successive captured images, and the corresponding distance information to estimate the relative distances between the moving object and the image obtaining unit 10 in the analyzed images and then computes the velocity of the moving object according to the analyzed images. For example, the distance between the moving object and the car at the first capturing time is 10 meter and the distance at the second capturing time is 9.8 meter. If the capturing time interval of the image obtaining unit 10 is 1 second, the velocity of the moving object can be known as 0.2 meter per second.

The determination module 18 analyzes the relative position between the moving object and the image obtaining unit 10 to determine whether the relative position is within the operating range of the door and whether the relative distance is smaller than a predetermined distance. In an embodiment, the predetermined distance of the determination module 18 can be a safe distance for the oncoming car according to the speed computed by the speed analysis module 15. In an embodiment, the predetermined distance can be a value predetermined directly by the user, such as 10 meter or 15 meter. Then, the determination module 18 determines the warning level of the moving object. The high warning level is determined by the determination module 18 when the relative position between the moving object and the image obtaining unit 10 is within the operating range of the door and the relative distance between the moving object and the image obtaining unit 10 is smaller than the predetermined distance (as shown in FIG. 3). At that time, the determination module 18 can transmit a first control signal. In addition, the low warning level is determined by the determination module 18 for transmitting a second control signal when the moving object is not moving within the operating range of the door or the relative distance between the moving object and the car is long enough for the moving object to dodge the opening door (as shown in FIG. 2).

The first warning unit 20 is installed on the inside of the door for warning the driver or the passenger and the second warning unit 22 is installed on the outside of the door for warning the oncoming traffic. When the determination module 18 transmits the second control signal, the sensing unit 26 can determine at the same time whether the door open unit is touched by the driver or the passenger. In an embodiment, the door open unit can be a door handle of a car. If the touch by the driver or the passenger is detected, it can be known that the driver or the passenger will open the door. At this time, the first warning unit 20 can provide a second warning signal to open a yellow caution light with the soft alarm for reminding the driver or the passenger to take care of the oncoming traffic before opening the door. Simultaneously, the second warning unit 22 also provides a fourth warning signal to open a yellow caution light with the soft alarm for reminding the oncoming traffic.

When the first warning unit 20 receives the first control signal, the first warning unit 20 will provide a first warning signal to open a red caution light with the rapid alarm for reminding the driver or the passenger not to open the door. Thereby, accidents can be prevented. If the door open unit is touched by the driver or the passenger and the touch action is detected by the sensing unit 26, it can be known that the driver or the passenger will open the door. At this time, the second warning unit 22 can provide a third warning signal to open a red caution light with the rapid alarm for reminding the oncoming traffic.

In the embodiment, if image obtaining units 10, first warning units 20 and second warning units 22 are installed on every door of the car, the determination module 18 can generate the first control signals or second control signals according to the respective warning levels of the doors. Therefore, the driver of the oncoming car or the pedestrian can know which door will be opened.

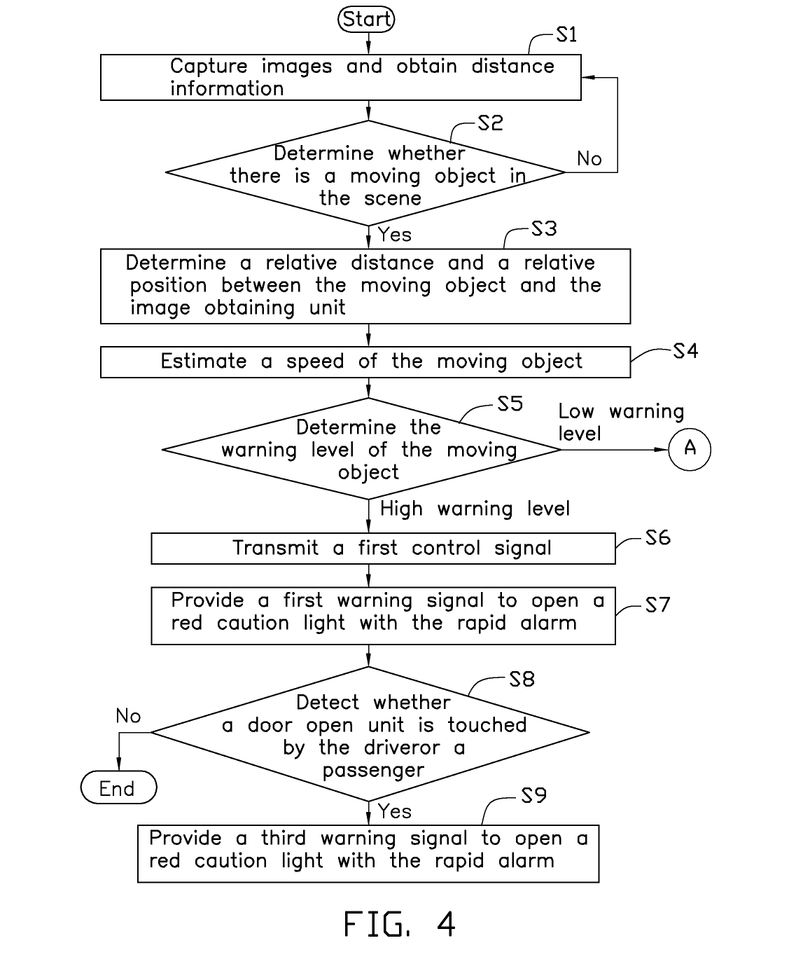

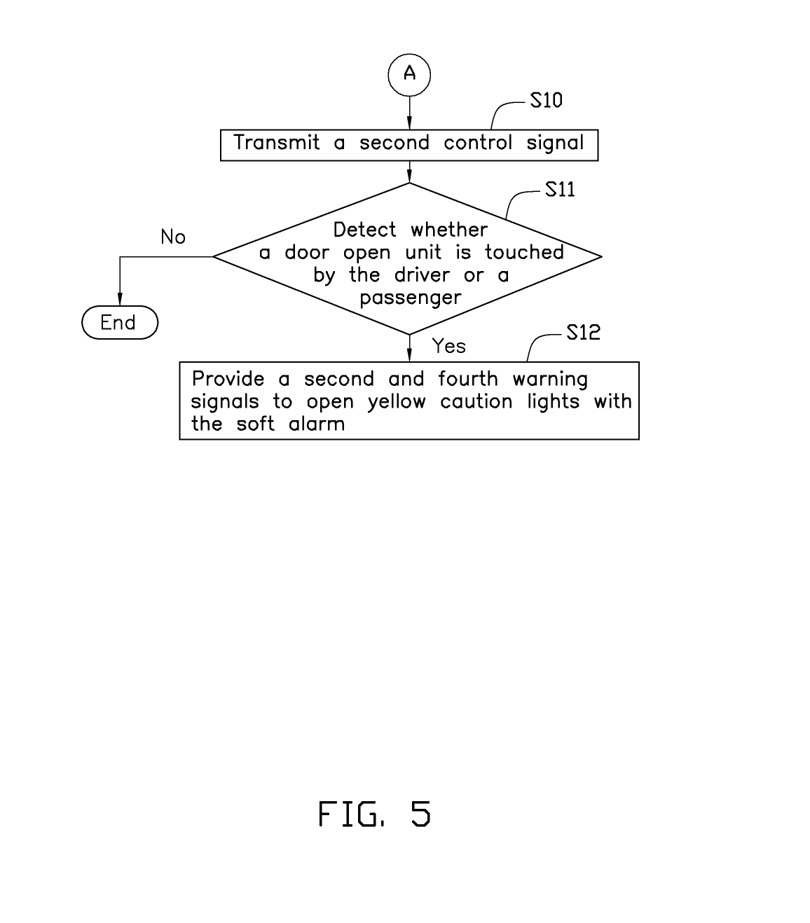

As shown in FIGS. 4 and 5, a preferred embodiment of the accident avoiding method is as follows:

In step S1, the image obtaining unit 10 is utilized to capture images of the scene behind the car, wherein each of the captured images include the distance information including distances between points on an object and the image obtaining unit 10. In an embodiment, the image obtaining unit 10 can be a TOF camera

In step S2, the detection module 12 analyzes the captured images and the distance information to determine whether there is a moving object in the scene. If there is no moving object in the scene, the procedure returns to step S1. If there is at least one moving object in the scene, the procedure goes to step S3.

In step S3, the location analysis module 16 analyzes the captured images and the distance information to determine a relative distance and a relative position between the moving object and the image obtaining unit 10.

In step S4, the speed analysis module 15 analyzes at least two of the captured images and the corresponding distance information to obtain the distances between the moving object and the image obtaining unit 10 in the at least two of the captured images. Then, the speed analysis module 15 estimates a speed of the moving object for determining whether the relative distance is smaller than a predetermined distance.

In step S5, the determination module 18 analyzes the relative position between the moving object and the image obtaining unit 10 to determine whether the relative position is within an operating range of a door and whether the relative distance is smaller than a predetermined distance. Thereby, the warning level of the moving object is determined by the determination module 18. If the moving object is moved within the operating range of the door and the relative distance between the moving object and the car is smaller than the predetermined distance, the warning level is determined as a high warning level and then the procedure goes to step S6. If the moving object is not moved within the operating range of the door or the relative distance between the moving object and the car is longer than or equal to the predetermined distance, the warning level is determined as a low warning level and then the procedure goes to step S10.

In step S6, the determination module 18 transmits a first control signal.

In step S7, the first warning unit 20 will provide a first warning signal to open a red caution light with the rapid alarm for reminding the driver or the passenger not to open the door.

In step S8, the sensing unit 26 detects whether a door open unit is touched by the driver or a passenger. If the touch by the driver or the passenger is detected by the sensing unit 26, the procedure goes to step S9. If there is no touched detected by the sensing unit 26, the first control signal can stop transmitting when the moving object leaves the captured scene.

In step S9, the second warning unit 22 will provide a third warning signal to open a red caution light with the rapid alarm for reminding the oncoming traffic.

In step 10, the determination module 18 transmits a second control signal.

In step 11, the sensing unit 26 detects whether a door open unit is touched by the driver or a passenger. If the touch by the driver or the passenger is detected by the sensing unit 26, the procedure goes to step S12. If there is no touched detected by the sensing unit 26, the second control signal can stop transmitting when the moving object leaves the captured scene.

In step 12, the first warning unit 20 can provide a second warning signal to open a yellow caution light with the soft alarm for reminding the driver or the passenger to take care of the situation behind the car before opening the door. Simultaneously, the second warning unit 22 also provides a fourth warning signal to open a yellow caution light with the soft alarm for reminding the oncoming traffic.

The above accident avoiding system and method is operated by using the image obtaining unit 10 to capture the images of the scene behind the car for determining whether there is a moving object or not. The accident avoiding system and method is further operated to estimate the position and the speed of the moving object to determine whether an accident will happen when opening the car door or not. Therefore the driver and the passenger will be reminded by the first warning unit 20 and the oncoming traffic will be reminded by the second warning unit 22.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An accident avoiding system, comprising:
an image obtaining unit configured to capture images, each of the captured images comprising a distance information including distances between points on an object and the image obtaining unit;
a detection module configured to analyze the captured images and the distance information to determine whether there is a moving object;
a location module configured to determine a relative distance and a relative position between the moving object and the image obtaining unit; and
a determination module configured to determine whether the relative position is within an operating range of a door and whether the relative distance is smaller than a predetermined distance.

2. The accident avoiding system of claim 1, wherein the determination module transmits a first control signal when the relative position is within the operating range of the door and the relative distance is smaller than the predetermined distance and the determination module transmits a second control signal upon one of conditions that the relative position is out of the operating range of the door and that the relative distance is larger than or equal to the predetermined distance.

3. The accident avoiding system of claim 2, further comprising:
a first warning unit configured to provide a first warning signal when the first warning unit receives the first control signal.

4. The accident avoiding system of claim 3, further comprising:
a sensing unit configured to detect whether a door open unit is touched.

5. The accident avoiding system of claim 4, wherein the first warning unit further provides a second warning signal when the first warning unit receives the second control signal and the door open unit is touched.

6. The accident avoiding system of claim 4, further comprising:
a second warning unit configured to provide a third warning signal during receiving the first control signal and a fourth warning signal during receiving the second control signal if the door open unit is touched.

7. The accident avoiding system of claim 1, wherein the image obtaining unit is a depth-sensing camera.

8. The accident avoiding system of claim 7, wherein the depth-sensing camera is a time of flight camera.

9. The accident avoiding system of claim 1, further comprising:
a speed analysis module configured to analyze at least two of the captured images and the corresponding distance information to estimate a speed of the moving object for the determination module.

10. An accident avoiding method, comprising:
using an image obtaining unit to capture images, each of the captured images comprising a distance information including distances between points on an object and the image obtaining unit;
analyzing the captured images and the distance information to determine whether there is a moving object;
determining a relative distance and a relative position between the moving object and the image obtaining unit; and
determining whether the relative position is within an operating range of a door and whether the relative distance is smaller than a predetermined distance.

11. The accident avoiding method of claim 10, further comprising:
transmitting a first control signal when the relative position is within the operating range of the door and the relative distance is smaller than the predetermined distance; and
transmitting a second control signal upon one of conditions that the relative position is out of the operating range of the door and that the relative distance is larger than or equal to the predetermined distance.

12. The accident avoiding method of claim 11, further comprising:
providing a first warning signal by a first warning unit when the first control signal is received.

13. The accident avoiding method of claim 12, further comprising:
detecting whether a door open unit is touched or not.

14. The accident avoiding method of claim 13, further comprising:
providing a second warning signal by the first warning unit when the second control signal is received and the door open unit is touched.

15. The accident avoiding method of claim 13, further comprising:
providing a third warning signal by a second warning unit during receiving the first control signal if the door open unit is touched; and
providing a fourth warning signal by the second warning unit during receiving the second control signal if the door open unit is touched.

16. The accident avoiding method of claim 10, wherein the image obtaining unit is a depth-sensing camera.

17. The accident avoiding method of claim 16, wherein the depth-sensing camera is a time of flight camera.

18. The accident avoiding method of claim 10, further comprising:
analyzing at least two of the captured images and the corresponding distance information to estimate a speed of the moving object for determining whether the relative distance is smaller than a predetermined distance.
